(19) United States
(12) Patent Application Publication
(10) Pub. No.: US 2026/0298739 A1
(43) Pub. Date: Oct. 1, 2026

(54) METHOD AND SYSTEM FOR MONITORING ICICLES BASED ON ADHESIVE OPTICAL FIBERS

(71) Applicant: SHANDONG UNIVERSITY, Jinan (CN)

(72) Inventors: Jianqing WU, Jinan (CN); Xinhao PAN, Jinan (CN); Xiuguang SONG, Jinan (CN); Hongbo ZHANG, Jinan (CN); Liping LI, Jinan (CN); Yuan TIAN, Jinan (CN); Cong DU, Jinan (CN); Jianzhu WANG, Jinan (CN); Xu WANG, Jinan (CN)

(21) Appl. No.: 19/459,060

(22) Filed: Jan. 26, 2026

(30) Foreign Application Priority Data
Apr. 1, 2025 (CN) 2025103967611

(51) Int. Cl. G01L 1/24; G01H 9/00; G01K 11/3206; G01K 15/00

(52) U.S. Cl. CPC G01L 1/242; G01H 9/004; G01K 11/3206; G01K 15/005

(57) ABSTRACT

A method for monitoring icicles based on adhesive optical fibers, may include: acquiring temperature signals, strain signals and vibration signals of eaves surface to be monitored by adhesive optical fibers; constructing icicle growth model; determining a risk index of a current risk indicator according to real-time growth status of icicle; performing multi-parameter fusion analysis according to risk index to assess risk of icicle falling; carrying out risk decision-making and early warning according to method of combining risk result of falling with dynamic threshold; and periodically carrying out component calibration and dynamic baseline correction according to the risk result of falling.

### CROSS-REFERENCE TO RELATED APPLICATIONS

The present invention claims priority benefits Chinese Patent Application number 202510396761.1, entitled “METHOD AND SYSTEM FOR MONITORING ICICLES BASED ON ADHESIVE OPTICAL FIBERS”, filed on Apr. 1, 2025, with the China National Intellectual Property Administration (CNIPA), the entire contents of which are incorporated herein by reference and form a part of the present invention for all purposes.

### TECHNICAL FIELD

The present invention relates to the technical field of optical fiber sensing technology and building safety monitoring, in particular to a method and system for monitoring icicles based on adhesive optical fibers.

### BACKGROUND

The statements in this section merely provide background information related to the present invention and do not necessarily constitute prior art.

In cold regions, icicles on eaves in winter pose a serious threat to the structural safety of buildings and the safety of pedestrians. Traditional methods for monitoring the growth of the icicles mainly rely on manual inspection or single temperature sensor. These methods have many limitations, including low efficiency, insufficient real-time performance and limited coverage. The cycle of manual inspection is limited by weather conditions and human resources. Usually, only limited inspections can be carried out in key areas every day, and the dynamic process of rapid growth of icicles cannot be effectively captured. In extreme weather conditions (such as snowstorms or strong winds), inspections are often interrupted, resulting in blind spots, further increasing safety hazards. Existing electronic temperature sensors (e.g. thermocouples, infrared sensors) are usually deployed only in localized areas of eaves and indirectly infer icing risk by monitoring ambient temperature. However, when the temperature is close to freezing point, these sensors cannot accurately distinguish between dry and wet surface conditions, and it is easy to misjudge the presence of condensed water as icing phenomenon, which makes it difficult to carry out risk warning. In addition, temperature sensors can only provide ambient temperature data and cannot directly evaluate the actual weight, stress distribution, and bond strength of icicles to building structures. This makes it extremely difficult to set early warning thresholds, which leads to insufficient accuracy and reliability of early warning systems. Therefore, traditional monitoring methods are difficult to meet the actual needs when dealing with the problem of eaves icicles, and it is urgent to develop more efficient, accurate and reliable monitoring technologies to effectively protect the safety of buildings and pedestrians in cold areas.

In recent years, optical fiber sensing technology has been widely used in various fields due to its remarkable advantages such as anti-electromagnetic interference, distributed measurement, high sensitivity and anti-harsh environment. For example, in the monitoring of large-scale infrastructure such as bridges, tunnels, and oil and gas pipelines, optical fiber sensing technology has demonstrated extremely high application value. However, the existing optical fiber monitoring system is mostly aimed at the deformation or temperature change of large structures (such as bridges and pipelines), and its installation method is complex, which is difficult to adapt to the narrow space of eaves and complex surfaces. The particularity of eaves icicle monitoring lays in its limited space and complex environment, which puts forward higher requirements for sensor size, installation mode and measurement accuracy. In addition, the application of existing optical fiber sensing technology in building structure health monitoring focuses on stress, strain or temperature monitoring of the overall structure, and it is difficult to directly apply it to eaves icicle monitoring.

To sum up, how to overcome the defect that the existing optical fiber sensing technology is difficult to apply in eaves, accurately quantify the risk of icicle, and realize the dynamic monitoring and early warning of the whole process of icicle has become a technical problem to be solved urgently in the prior art.

### SUMMARY

For overcoming the defects of the prior art, the present invention aims to provide a method and system for monitoring icicles based on adhesive optical fibers, may monitor the icicle condition of eaves in real time using the adhesive optical fiber sensors, and perform multi-parameter fusion analysis and anti-interference design based on the icicle influencing factors, so as to realize the real-time monitoring and risk early warning of the icicle on eaves of buildings in cold areas.

In order to achieve the above objectives, the present invention is realized through the following technical solutions.

A first aspect of the present invention provides a method for monitoring icicles based on adhesive optical fibers, including the following steps:
sticking the adhesive optical fibers on an eaves surface to be monitored to collect temperature signal, strain signal and vibration signal of the eaves surface to be monitored;
preprocessing the collected signals;
constructing an icicle growth model according to the preprocessed signals, and monitoring growth status of the icicles based on the constructed icicle growth model;
selecting a risk indicator, and determining a risk index of a current risk indicator according to a real-time growth status of the icicles;
carrying out a multi-parameter fusion analysis according to the risk index, to obtain an icicle-falling risk assessment value (IFRAV);
comparing the IFRAV with a dynamic threshold value: when the IFRAV is greater than the dynamic threshold value within a first range, starting an acousto-optic alarm to inform roadside pedestrians of a risk of icicles falling; or, when the IFRAV is greater than the dynamic threshold value within a second range, starting the acousto-optic alarm, simultaneously intervening falling of the icicles; and
carrying out a periodic component calibration and dynamic baseline correction based on the IFRAV.

Further, collecting the temperature signal, strain signal and vibration signal of the eaves surface to be monitored by using the adhesive optical fiber, including:
designing a deployment density of the adhesive optical fibers and a node spacing of a fiber bragg grating (FBG);
sticking the adhesive optical fibers on the eaves surface to be monitored according to the design, and collecting the signals according to a change of optical wavelength of the adhesive optical fibers.

Furthermore, before sticking the adhesive optical fibers on the eaves surface to be monitored according to the design, making a sticking area flat and clean, then applying a primer adhesive to the sticking area, and then sticking the adhesive optical fibers to a lower surface of the eaves in an array form.

Further, preprocessing the collected signals, including:
capturing a micro-vibration of the icicles by using discrete wavelet de-noising; and
amplifying a peak value of an icicle point by using temperature-strain decoupling.

Further, constructing the icicle growth model according to the preprocessed signals, including:
using an icing rate of the icicles to reflect an ice layer expansion rate;
using a strain abrupt change to reflect a severe degree of local deformation of the adhesive optical fibers; and
quantifying a vibration energy to describe cracks inside the icicles.

Further, determining the risk index of the current risk indicator according to the real-time growth status of the icicles, including:
classifying risk indexes according to the risk indicator by using a classical random forest algorithm;
calculating the risk index according to the real time growth status of the icicles and adaptively adjusting a weight of risk; and
adjusting the dynamic early warning threshold according to different environmental temperatures.

Further, carrying out the periodic component calibration and dynamic baseline correction based on the IFRAV, including:
performing a thermal calibration of a temperature sensor of the adhesive optical fibers; and
setting sliding windows, and dynamically updating an ice-free data baseline.

A second aspect of the present invention provides a system for monitoring icicles based on adhesive optical fibers, including:
a data acquisition module, configured to acquire a temperature signal, a strain signal and a vibration signal of an eaves surface to be monitored by using adhesive optical fibers, and preprocess the acquired signals;
a growth condition monitoring module, configured to construct an icicle growth model based on the acquired signals, and monitor a growth status of the icicles based on the icicle growth model;
a risk index determining module, configured to select a risk indicator and determine a risk index of a current risk indicator according to a real-time growth status of the icicles;
a risk assessment module, configured to perform multi-parameter fusion analysis according to the risk index and output an IFRAV; and
a decision early warning module, configured to make risk decision and early warning according to a method of combining the IFRAV with a dynamic threshold, and periodically perform component calibration and dynamic baseline correction according to the IFRAV;
wherein, comparing the IFRAV with a dynamic threshold value: when the IFRAV is greater than the dynamic threshold value within a first range, starting an acousto-optic alarm to inform roadside pedestrians of a risk of icicles falling; or, when the IFRAV is greater than the dynamic threshold value within a second range, starting the acousto-optic alarm, simultaneously intervening falling of the icicles.

A third aspect of the present invention provides a medium having a program store thereon, when the program is executed by a processor, causing the processor to implement the steps of the method for monitoring the icicles base on the adhesive optical fibers according to the first aspect of the invention.

A fourth aspect of the present invention provides an apparatus comprising a memory, a processor, and a program stored on the memory and executable on the processor, when the processor executes the program, causing the processor to implement the steps of the method for monitoring the icicles base on the adhesive optical fibers according to the first aspect of the invention.

One or more of the above technical solutions have the following beneficial effects:

According to the present invention, the method and system for monitoring the icicles based on the adhesive type optical fibers proposed, may comprehensively consider the full-cycle requirement of eaves icicle monitoring, perform dynamic monitoring and early warning on the whole process from icicle formation, growth to dropping, acquire temperature, strain and vibration signals in real time through an adhesive type optical fiber sensor network, and realize accurate quantitative evaluation of icicle risks by combining multi-parameter fusion analysis and a machine learning algorithm. Compared with the traditional manual inspection or single sensor monitoring method, the invention solves the problems of monitoring fragmentation, early warning lag, high false alarm rate and the like, significantly improves monitoring efficiency and early warning precision, and provides reliable guarantee for building safety in cold areas.

According to the present invention, the convenient deployment and flexible design of the adhesive type optical fiber, may be suitable for complex surfaces of various eaves structures, does not need drilling or mechanical fixing, and obviously reduces installation cost and construction difficulty. At the same time, the optimized design of waterproof layer and protective coating ensures the long-term stability of optical fiber in low temperature and high humidity environment, solves the pain point of traditional monitoring equipment vulnerable to environmental interference and high maintenance cost, and has a wide application prospect.

According to the present invention, through a cooperative mechanism of heating calibration and baseline correction, zero drift of the sensor is eliminated regularly, the ice-free data baseline is dynamically updated, the environment gradual change and seasonal change are adapted, and the long-term reliability of monitoring data is guaranteed. In addition, multi-sensor data fusion and anomaly detection mechanism effectively improve the anti-interference ability and fault tolerance of the system, avoid monitoring interruption caused by single point failure, and ensure the continuous and stable operation of the system.

According to the present invention, intelligent grading early warning of the risk of icicles falling is realized through a random forest classifier and a dynamic threshold adjusting mechanism. By adjusting the warning threshold adaptively according to the ambient temperature, the limitation of traditional methods relying on fixed threshold is avoided, and the false positive rate and false negative rate are significantly reduced. At the same time, the warning information is pushed in real time through the sound-light alarm and wireless communication module, supporting remote monitoring and rapid response, providing efficient technical means for building safety management.

According to the present invention, through the construction and optimization of the icicle growth model, historical data and real-time monitoring feedback are combined, model parameters are dynamically adjusted, and the accuracy of risk prediction is improved. Compared with the traditional empirical threshold method, the invention has higher scientificity and adaptability, can cope with complex and changeable climatic conditions, and provides an innovative solution for the field of icicle monitoring.

Advantages of additional aspects of the invention will be set forth in part in the following description, and in part will become apparent from the following description, or may be learned by practice of the invention.

### BRIEF DESCRIPTION OF THE DRAWINGS

The accompanying drawings constituting a part of the present invention are used to provide a further understanding of the present invention. The exemplary examples of the present invention and descriptions thereof are used to explain the present invention, and do not constitute an improper limitation of the present invention.

FIG. 1 is a flow chart of a method for monitoring icicles based on adhesive optical fibers in Example 1 of the present invention;

FIG. 2 is a sectional view of an adhesive optical fiber according to the Example 1 of the present invention.

### DETAILED DESCRIPTION

It should be pointed out that the following detailed descriptions are all illustrative and are intended to provide further descriptions of the present invention. Unless otherwise specified, all technical and scientific terms used in the present invention have the same meanings as those usually understood by a person of ordinary skill in the art to which the present invention belongs.

It should be noted that the terms used herein are merely used for describing specific implementations, and are not intended to limit exemplary implementations of the present invention. As used herein, the singular form is also intended to include the plural form unless the context clearly dictates otherwise. In addition, it should further be understood that, terms “comprise/comprising” and/or “include/including” used in this specification indicate that there are features, steps, operations, devices, components, and/or combinations thereof.

### Explanation of Terms

Adhesive Optical Fiber: a special type of fiber coated with a flexible adhesive layer, designed for direct adhesion to buildings or other structural surfaces. It is designed to achieve real-time, continuous monitoring of distributed physical quantities such as temperature, strain, vibration, etc. Through the adhesion of the flexible adhesive layer, the optical fiber can be closely attached to the surface of the monitored object, so as to accurately sense the change of its physical state.

Fiber Bragg Grating (FBG): a periodic refractive index modulated structure written in the core of an optical fiber by ultraviolet laser light. It works by reflecting light at a specific wavelength using periodic arrangements of gratings, which shift with changes in external physical quantities such as temperature and strain. This characteristic enables fiber grating to convert the change of physical quantity into the change of optical wavelength, thus realizing high precision sensing measurement.

Distributed Acoustic Sensing (DAS): uses phase changes of backscattered light in an optical fiber to detect vibration signals distributed along the fiber. The DAS technology can monitor minute vibrations along the fiber in real time by analyzing the optical signal changes inside the fiber. The core principle is to use the optical fiber itself as a sensor to realize distributed monitoring of long distance areas by detecting vibration events along the optical fiber.

Icicle Growth Model (IGM): a mathematical model based on thermodynamics and mechanics to describe the formation, growth, and shedding of icicles on eaves. The model considers the external conditions such as ambient temperature, humidity, wind speed, and solar radiation, as well as the internal factors such as heat conduction characteristics of eaves surface, weight distribution of icicles and stress variation.

### Example 1

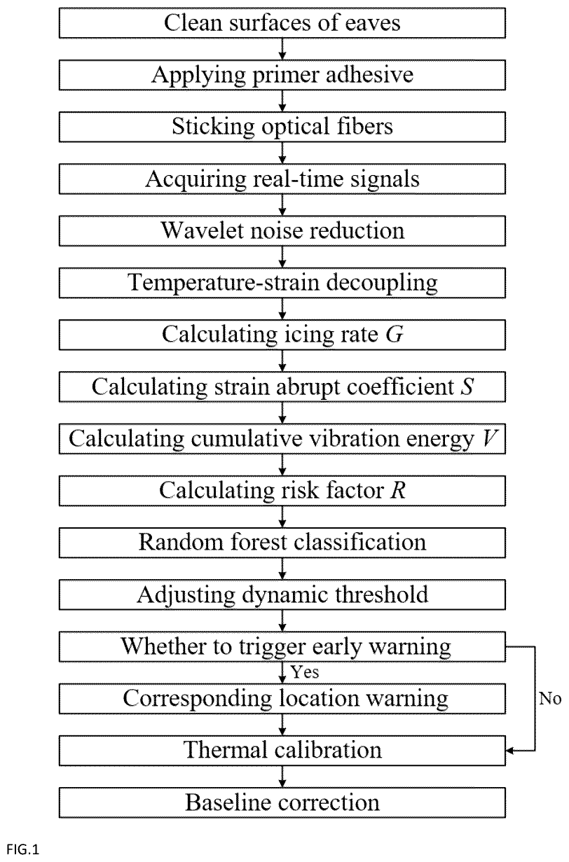

The present example provides a method for monitoring icicles based on adhesive optical fibers, as shown in FIG. 1, the method includes the following steps:

Step 1: acquiring a temperature signal, a strain signal and a vibration signal of an eaves surface to be monitored by using adhesive optical fibers, and preprocessing the acquired signals.

Specifically:

Step 1.1: acquiring the temperature signal, the strain signal and the vibration signal of the eaves surface to be monitored by using the adhesive optical fibers.

Step 1.1.1: designing a deployment density of the adhesive optical fibers and a node spacing of FBG.

In a specific implementation mode, a calculation of the deployment density of the adhesive optical fibers is determined by a length of the eaves and a maximum predicted length of icicles:

$${N}_{fiber} = ⌈ \frac{L}{0.8 {l}_{max}} ⌉ ;$$

wherein, N_{fiber} is the deployment density of the adhesive optical fibers; L is the eaves length; lₘₐₓ is the maximum predicted length of icicles, calculated from historical meteorological data (such as snow accumulation, daily average temperature) and eaves inclination angle; 0.8 is the redundancy factor, ensuring that there is 20% overlap in adjacent fiber coverage areas, avoiding monitoring blind areas, and correcting the lₘₐₓ at the same time.

Step 1.2: design of the node spacing of the FBG, determined by spatial resolution requirements:

$$d = \frac{c}{2 {n}_{eff} {f}_{s a m p l e}} ;$$

wherein, d is the node spacing of the FBG, fₛₐₘₚₗₑ is sampling frequency, c is light speed, and n_{eff} is effective refractive index of fiber.

Step 1.1.2: sticking optical fibers on the eaves surface according to the design, and collecting the signals according to changes of wavelength of the optical fibers.

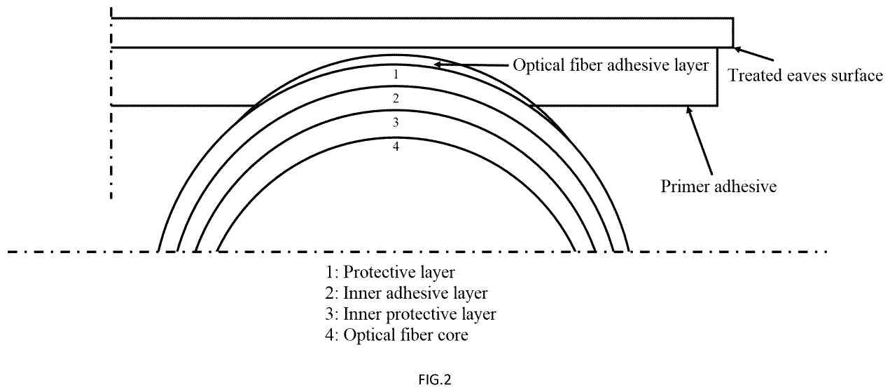

In a specific implementation mode, before sticking the optical fibers on the eaves surface according to the design, the sticking area is ensured first to be flat and clean without factors affecting the adhesion force of the optical fibers such as oil stains, and then the primer adhesive is applied, and the optical fibers are pasted to a lower surface of the eaves in an array form (such as V-shape or S-shape), as shown in FIG. 2.

In the present example, flexible optical fibers are adhered to the eaves surface in the array form to form a dense monitoring grid. By using FBG or DAS technology, sensor networks can monitor temperature, strain and vibration signals on eaves surfaces in real time. The FBG technology uses the change of grating reflection wavelength to sense small changes in temperature and strain, while the DAS technology captures vibration signals by detecting acoustic wave propagation characteristics along the fiber.

Step 1.2: preprocessing the collected signals.

Step 1.2.1: capturing icicle micro-vibration by using discrete wavelet de-noising, may avoid signal aliasing, and retain waveform characteristics without damaging abrupt values.

In a specific implementation mode, the discrete wavelet de-noising is used for preprocessing, a wavelet base is selected as Db4, a number of decomposition layers is 5, and the signal in the frequency band of 1-100 Hz is reserved:

$${W}_{ψ} f ( a , b ) = \frac{1}{\sqrt{a}} {\int }_{- ∞}^{+ ∞} f ( t ) {ψ}^{*} ( \frac{t - b}{a} ) dt ;$$

wherein, W_{ψ}f(a, b) represents the processed waveform, ψ(⋅) is wavelet basis function; α is scale factor, and is used to determine the noise reduction range; b is translation factor, and is used to modify the waveform.

Step 1.2.2: correcting the strain error caused by thermal expansion of optical fiber by temperature-strain decoupling, to further amplify the peak value of icicle point.

In a specific implementation mode, the equation of the temperature-strain decoupling

$${ε}_{real} = {ε}_{means} - α \cdot Δ T ,$$

$$Δ T = \frac{Δ {λ}_{B}}{{K}_{T}} ;$$

wherein, εᵣₑₐₗ is the corrected optical fiber strain; εₘₑₐₙₛ is the measured optical fiber strain; α is the optical fiber thermal expansion coefficient, generally set as 0.55×10⁻⁶/° C.; ΔT is the temperature change; Δλ_{B} is the wavelength offset; K_{T} is the temperature sensitivity, generally set as 10 μm/° C.

Step 2: constructing an IGM according to the acquired signals, and monitoring growth status of the icicles based on the constructed IGM.

Specifically:

Step 2.1: constructing the IGM according to the acquired signals.

The IGM was constructed by combining the icing rate, strain mutation and cumulative vibration energy changes, and the key characteristics of icicle formation, growth and shedding were identified. The growth state of icicle is quantified by the IGM, and natural vibration and risk signal are distinguished by vibration energy integration method. The icicle state is expressed from thermodynamics, mechanics and vibration characteristics respectively, and the risk index is formed together.

Step 2.1.1: using icing rate of icicle to reflect an ice layer expansion rate.

In a specific implementation mode, the icing rate of icicle is calculated to directly reflect the ice layer expansion rate:

$$G = \frac{\partial T \cdot {k}_{i c e} \cdot {A}_{c o n t a c t}}{\partial t \cdot {Q}_{latent}} ,$$

$${A}_{c o n t a c t} = {N}_{f i b e r} \cdot {ω}_{f i b e r} \cdot d ;$$

wherein, A_{contact} represents the icing rate of icicle,

$$\frac{\partial T}{\partial t}$$

represents temperature change rate with time; k_{ice} is ice thermal conductivity; Qₗₐₜₑₙₜ is ice latent heat, generally set as 334 KJ/Kg; G is ice spreading speed, one of the criteria for measuring the risk rating of icicle falling; ω_{fiber} represents actual lateral extension speed of icicle along the eaves surface.

Step 2.1.2: using strain abrupt change to reflect severe degree of local deformation of optical fibers.

In a specific implementation mode, the strain abrupt change is calculated to reflect the severity of the local deformation of the optical fiber:

$$S = max ( \vert {ε}_{t + 1} - 2 {ε}_{t} + {ε}_{t - 1} \vert ) ;$$

wherein, εₜ is the corrected strain at time t; εₜ₊₁ and εₜ₋₁ are the strain values at adjacent time; S is the mutation coefficient, one of the criteria for measuring the risk rating of icicle falling.

Step 2.1.3: quantifying the vibration energy to describe the crack inside the icicles.

In a specific implementation mode, the vibration energy is quantified to describe the internal crack of the ice cone:

$$V = {\int }_{1 H z}^{100 H z} {\vert F ( ω ) \vert}^{2} d ω ;$$

wherein, F(ω) is the Fourier transform of moving signal, and represents energy distribution of signal in frequency domain; V represents accumulated vibration energy, one of the criteria for measuring the risk rating of icicle falling.

Step 2.2: monitoring growth status of the icicles based on the IGM.

Specifically, by monitoring whether the ice layer expands, whether the optical fiber is partially deformed, and whether the accumulated vibration energy reaches the threshold, the growth status of the icicles is monitored.

Step 3: selecting a risk indicator, and determining a risk index of a current risk indicator according to the real-time growth status of the icicle.

In the present example, the icing rate is taken as the dominant factor, the mechanical and vibration characteristics are considered, the fall risk is evaluated through multi-parameter fusion, and then the decision is made in combination with the dynamic threshold method. And random forest algorithm is used to classify the monitoring data, and realize the dynamic classification warning and adaptive adjustment of weight of the risk of icicles falling.

Specifically:

Step 3.1: selecting the risk indicator.

In the present example, the ice layer expansion speed, the local deformation speed of the optical fiber and the accumulated vibration energy degree are taken as risk indicators.

Step 3.2: determining the risk index of the current risk index according to the real-time growth status of icicle.

In a specific implementation mode, the calculation of the risk index and the adaptively adjustment of risk weights are as follows:

$$R = α G + β S + γ V ,$$

$$α , β , γ = arg min ( {\sum }_{i = 1}^{N} {( {R}_{i} - {R}_{t u r e , i} )}^{2} ) ;$$

wherein, R represents risk index; α, β, γ respectively corresponds to the weight of ice layer expansion speed, the weight of mutation coefficient, and the weight of cumulative vibration energy weight, which are rough set at initial calculation, and adjusted adaptively after the initial calculation. Rᵢ represents the predicted value of the risk index of an i^{th} set of data; R_{ture,i} represents the true risk index, calculated by the classical random forest algorithm.

Step 3.3: classifying risk indexes according to the risk indicators by the classical random forest algorithm.

In a specific implementation mode, the risk indexes are classified by the classical random forest algorithm, wherein the input characteristics thereof are: risk index R, risk index change rate

$$\frac{\partial R}{\partial t} ,$$

vibration peak value Vₚₑₐₖ, and the output thereof is: real risk index R_{ture,i}, which is used for weight adaptation in step 3.2.

Step 3.4: calculating the risk index according to the real-time growth status of icicles and adaptively adjusting weights of the risk.

Specifically, when R>R_{crit}, executing an alarm on a corresponding position, wherein R_{crit} is a dynamic threshold; when R≤R_{crit}, the data is used as feedback to correct the weight according to step 3.2 and step 3.3.

Step 3.5: adjusting the dynamic (warning) threshold according to different environment temperatures.

In a specific implementation mode, the adjustment of the dynamic threshold according to different environment temperatures, is as follows:

$${R}_{c r i t} = {R}_{b a s e} \cdot ( 1 + η \cdot \frac{{T}_{e n v} - {T}_{r e f}}{{T}_{r e f}} ) ;$$

wherein, R_{crit} is the dynamic threshold; R_{base} is the reference threshold, set according to the environmental conditions; n is the temperature sensitivity factor, set according to the early warning sensitivity requirements; Tₑₙᵥ is the current environmental temperature; T_{ref} is the reference environmental temperature, recommended as 0 C° (ice melting limit temperature).

Step 4: carrying out a multi-parameter fusion analysis according to the risk index, to output an IFRAV.

Step 5: making risk decision and early warning according to the method of combining the IFRAV with the dynamic threshold, and periodically performing component calibration and dynamic baseline correction according to the IFRAV.

In the present example, sensor drift and environmental interference are eliminated through periodic calibration and dynamic baseline correction, so as to ensure data reliability and early warning accuracy and ensure long-term stable operation of the monitoring system.

Specifically:

Step 5.1: making the risk decision and the early warning according to the method of combining the IFRAV with the dynamic threshold, including:
comparing the IFRAV with a dynamic threshold value: when the IFRAV is greater than the dynamic threshold value within a first range, starting an acousto-optic alarm to inform roadside pedestrians of a risk of icicles falling; or, when the IFRAV is greater than the dynamic threshold value within a second range, starting the acousto-optic alarm, simultaneously intervening falling of the icicles; wherein, the second range is greater than the first range.

Step 5.2: periodically performing the component calibration and the dynamic baseline correction according to the IFRAV.

Step 5.2.1: performing the thermal calibration on optical fiber temperature sensor.

In the present example, the zero-point drift is eliminated by performing the thermal calibration on the optical fiber temperature sensor to ensure temperature measurement accuracy. Specifically, the zero drift of temperature sensor is corrected by recording the wavelength shift of FBG before and after heating.

Step 5.2.2: setting sliding windows to dynamically update ice-free data baseline. The ice-free data baseline is the data when there is no ice, which is used to compare with the data after ice formation to realize icicle monitoring.

In a specific implementation mode, sliding windows (periodic calibration period) are set to eliminate the impact of environmental gradients (such as seasonal changes) on monitoring results by dynamically updating the ice-free data baseline. The calculation formula of the baseline is as follows:

$${σ}_{new}^{2} = λ \cdot {σ}_{old}^{2} + ( 1 - λ ) \cdot {σ}_{current}^{2} ;$$

wherein,

$${σ}_{new}^{2}$$

a current sliding window of a certain monitoring data of the optical fiber;

$${σ}_{old}^{2}$$

a previous sliding window on the certain monitoring data of the optical fiber;

$${σ}_{current}^{2}$$

is the variance of the current sliding window of the certain monitoring data of the optical fiber; A is a forgetting factor and needs to be adjusted according to different monitoring requirements.

Step 5.3: calculating whether calibration is initiated.

Specifically:
if

$${σ}_{new}^{2} > ρ \cdot {σ}_{old}^{2} ,$$

initiating a manual calibration; if

$${σ}_{new}^{2} < ρ \cdot {σ}_{old}^{2} ,$$

updating variance baseline for subsequent calculations;
wherein, ρ is the calibration sensitivity coefficient, which is set according to the actual situation.

In the present example, an environmental noise filtering algorithm and a temperature-based strain compensation mechanism are introduced to eliminate the influence of interference factors such as wind power and sunshine on monitoring results.

In order to better illustrate the effect of the method of the present example, a commercial building in a certain city is taken as an example for illustration:
wherein, a length of the eaves L=20 m, a 13-channel adhesive optical fiber sensor (N_{fiber}=13) is mounted; winter daily temperature is −5° C., and a minimum temperature at night is −15° C.;
S1: cleaning the surfaces of the eaves, applying a primer adhesive, sticking the optical fiber with node spacing d=0.1 m.
S2: collecting temperature and strain signals by FBG, collecting vibration signals by DAS, wherein the sampling frequency is 2 kHz.
S3: performing the wavelet noise reduction and temperature-strain decoupling.
S4: calculating icing rate G:
calculating the change rate of temperature

$$\frac{\partial T}{\partial t} = - 0.2 ° C . / min ;$$

calculating Ice layer contact area A_{contact}=13×5 mm×0.1 m=0.0065 m²;
then, icing rate G=0.12%, indicating that icicles are slowly growing.
S5: calculating strain abrupt coefficient S, assuming S=0.12%, indicating that eaves deformation intensifies.
S6: calculating the cumulative vibration energy V, assuming V=0.05 Pa²·s, indicating that the crack energy inside the icicle is low.
S7: calculating risk factor R, assuming weighting factors α, β, γ are 0.6, 0.3, 0.1, respectively; then R=0.045.
S8: inputting random forest classification, assuming the output is low risk.
S9: adjusting dynamic thresholds, assuming η=0.2, and R_{base}=0.75; then R_{crit}=0.6.
S10: executing the early warning; when R=0.045<R_{crit}=0.6, no early warning triggered.
S11: performing the thermal calibration and baseline correction.

### Example 2

The present example provides a system for monitoring icicles based on adhesive optical fibers, including:
a data acquisition module, configured to acquire a temperature signal, a strain signal and a vibration signal of an eaves surface to be monitored by using adhesive optical fibers, and preprocess the acquired signals;
a growth condition monitoring module, configured to construct an icicle growth model (IGM) based on the acquired signals, and monitor a growth status of the icicles based on the icicle growth model;
a risk index determining module, configured to select a risk indicator and determine a risk index of a current risk indicator according to a real-time growth status of the icicles;
a risk assessment module, configured to perform multi-parameter fusion analysis according to the risk index and output an icicle-falling risk assessment value (IFRAV);
a decision early warning module, configured to make risk decision and early warning according to a method of combining the IFRAV with a dynamic threshold, and periodically perform component calibration and dynamic baseline correction according to the IFRAV;
wherein, comparing the IFRAV with a dynamic threshold value: when the IFRAV is greater than the dynamic threshold value within a first range, starting an acousto-optic alarm to inform roadside pedestrians of a risk of icicles falling; or, when the IFRAV is greater than the dynamic threshold value within a second range, starting the acousto-optic alarm, simultaneously intervening falling of the icicles.

### Example 3

The present example provides a non-transitory computer-readable storage medium having a program stored thereon, when the program is executed by a processor, causing the processor to implement the steps of the method for monitoring the icicles base on the adhesive optical fibers according to Example 1 of the present invention.

### Example 4

The present example provides an apparatus, comprising a memory, a processor, and a program stored in the memory and operable on the processor, wherein the processor executes the program to cause the processor to implement the steps of the method for monitoring the icicles base on the adhesive optical fibers according to Example 1 of the present invention.

Each step involved in the above examples 2, 3 and 4 corresponds to the method according to the Example 1, and for a specific implementation mode, please refer to the relevant description part of the Example 1.

Those skilled in the art will appreciate that the various modules or steps of the invention described above may be implemented using general purpose computer means, alternatively they may be implemented using program code executable by computing means such that they may be stored in memory means for execution by computing means, or fabricated separately as individual integrated circuit modules, or multiple of them may be fabricated as a single integrated circuit module. The present invention is not limited to any particular combination of hardware and software.

Although the specific embodiments of the present invention are described above in combination with the accompanying drawings, it is not a limitation on the protection scope of the present invention. Those skilled in the art should understand that on the basis of the technical scheme of the present invention, various modifications or deformations that can be made by those skilled in the art without creative labor are still within the protection scope of the present invention.

1. A method for monitoring icicles based on adhesive optical fibers, comprising:
acquiring a temperature signal, a strain signal and a vibration signal of an eaves surface to be monitored by using adhesive optical fibers, and preprocessing the acquired signals;
wherein, the adhesive optical fibers are adhered to the eaves surface in an array form;
constructing an icicle growth model (IGM) according to the acquired signals, and monitoring growth status of the icicles based on the constructed IGM;
wherein, constructing the IGM according to the acquired signals comprises:
using an icing rate of icicle to reflect an ice layer expansion rate;
using a strain abrupt change to reflect a severe degree of a local deformation of an optical fiber; and
quantifying a vibration energy to describe cracks inside the icicles;
wherein, using the icing rate of icicle to reflect the ice layer expansion rate, comprises:
$$G = \frac{\partial T \cdot {k}_{ice} \cdot {A}_{contact}}{\partial t \cdot {Q}_{latent}} ,$$
$${A}_{contact} = {N}_{fiber} \cdot {ω}_{fiber} \cdot d ;$$
wherein, A_{contact} represents the icing rate of icicle
$$\frac{\partial T}{\partial t}$$
represents temperature change rate with time; k_{ice} is ice thermal conductivity; Qₗₐₜₑₙₜ is ice latent heat; d is a node spacing of FBG; N_{fiber} is a deployment density of the optical fiber; G is ice spreading speed, one of the criteria for measuring the risk rating of icicle falling;
using the strain abrupt change to reflect the severe degree of the local deformation of the optical fiber comprises:
$$S = max ( \vert {ε}_{t + 1} - 2 {ε}_{t} + {ε}_{t - 1} \vert ) ;$$
wherein, εₜ is a corrected strain at time t; εₜ₊₁ and εₜ₋₁ are strain values at adjacent times; S is a mutation coefficient, one of the criteria for measuring the risk rating of icicle falling;
quantifying the vibration energy to describe the cracks inside the icicles comprises:
$$V = {\int }_{1 Hz}^{100 Hz} {\vert F ( ω ) \vert}^{2} d ω ;$$
wherein, F(ω) is the Fourier transform of a moving signal, and represents energy distribution of the signal in a frequency domain; V represents an accumulated vibration energy, one of the criteria for measuring the risk rating of icicle falling;
selecting a risk indicator, and determining a risk index of a current risk indicator according to a real-time growth status of the icicle;
carrying out a multi-parameter fusion analysis according to the risk index, to assess a risk of icicles falling; and
performing a risk decision and an early warning according to a method of combining results of risk of falling with a dynamic threshold, and periodically performing component calibration and dynamic baseline correction according to the results of risk of falling.

2. The method for monitoring icicles based on adhesive optical fiber according to claim 1, wherein acquiring the temperature signal, the strain signal and the vibration signal of the eaves surface to be monitored by using the adhesive optical fibers, specifically comprises steps as follows:
designing the deployment density of the optical fiber and a node spacing of a fiber bragg grating (FBG); and
sticking the optical fiber on the eaves surface according to the design, and acquiring the signals according to a change of a wavelength of the optical fiber.

3. The method for monitoring icicles based on adhesive optical fiber according to claim 2, wherein when sticking the optical fiber on the eaves surface according to the design, a sticking area is ensured to be flat and clean, and then applying a primer adhesive, and sticking the optical fiber on a lower surface of the eaves in the array form.

4. The method for monitoring icicles based on adhesive optical fiber according to claim 1, wherein preprocessing the acquired signals, specifically comprises steps as follows:
capturing icicle micro-vibration by using a discrete wavelet de-noising; and
further amplifying a peak value of an icicle point by using temperature-strain decoupling.

5. The method for monitoring icicles based on adhesive optical fiber according to claim 1, wherein determining the risk index of the current risk indicator according to the real-time growth status of the icicle, specifically comprises steps as follows:
classifying risk indexes according to risk indicators by using a classical random forest algorithm;
calculating the risk index according to the real-time growth status of icicles and adaptively adjusting weights of the risk; and
adjusting a dynamic warning threshold according to different environment temperatures.

6. The method for monitoring icicles based on adhesive optical fiber according to claim 1, wherein periodically performing the component calibration and the dynamic baseline correction according to the results of the risk of falling, specifically comprises steps as follows:
performing a thermal calibration on an optical fiber temperature sensor; and
setting sliding windows to dynamically update an ice-free data baseline.

7. A system for monitoring icicles based on adhesive optical fibers, comprising:
a data acquisition module, configured to acquire a temperature signal, a strain signal and a vibration signal of an eaves surface to be monitored by using adhesive optical fibers, and preprocess the acquired signals;
wherein, the adhesive optical fibers are adhered to the eaves surface in an array form;
a growth condition monitoring module, configured to construct an icicle growth model (IGM) based on the acquired signals, and monitor a growth status of the icicles based on the IGM;
wherein, constructing the IGM according to the acquired signals comprises:
using an icing rate of icicle to reflect an ice layer expansion rate;
using a strain abrupt change to reflect a severe degree of a local deformation of an optical fiber; and
quantifying a vibration energy to describe cracks inside the icicles;
wherein, using the icing rate of icicle to reflect the ice layer expansion rate, comprises:
$$G = \frac{\partial T \cdot {k}_{ice} \cdot {A}_{contact}}{\partial t \cdot {Q}_{latent}} ,$$
$${A}_{contact} = {N}_{fiber} \cdot {ω}_{fiber} \cdot d ;$$
wherein, A_{contact} represents the icing rate of icicle,
$$\frac{\partial T}{\partial t}$$
represents temperature change rate with time; k_{ice} is ice thermal conductivity; Qₗₐₜₑₙₜ is ice latent heat; d is a node spacing of FBG; N_{fiber} is a deployment density of the optical fiber; G is ice spreading speed, one of the criteria for measuring the risk rating of icicle falling;
using the strain abrupt change to reflect the severe degree of the local deformation of the optical fiber comprises:
$$S = max ( \vert {ε}_{t + 1} - 2 {ε}_{t} + {ε}_{t - 1} \vert ) ;$$
wherein, εₜ is a corrected strain at time t; εₜ₊₁ and εₜ₋₁ are strain values at adjacent times; S is a mutation coefficient, one of the criteria for measuring the risk rating of icicle falling;
quantifying the vibration energy to describe the cracks inside the icicles comprises:
$$V = {\int }_{1 Hz}^{100 Hz} {\vert F ( ω ) \vert}^{2} d ω ;$$
wherein, F(ω) is the Fourier transform of a moving signal, and represents energy distribution of the signal in a frequency domain; V represents an accumulated vibration energy, one of the criteria for measuring the risk rating of icicle falling;
a risk index determining module, configured to select a risk indicator and determine a risk index of a current risk indicator according to a real-time growth status of the icicles;
a risk assessment module, configured to perform a multi-parameter fusion analysis according to the risk index, and assess a risk of icicles falling; and
a decision early warning module, configured to perform a risk decision and an early warning according to a method of combining results of risk of falling with a dynamic threshold, and periodically perform component calibration and dynamic baseline correction according to the results of risk of falling.

8. A computer-readable storage medium, having a plurality of instructions stored thereon, when the instructions are executed by a processor, causing the processor to implement the steps of the method for monitoring the icicles base on the adhesive optical fibers according to claim 1.

9. A terminal device, comprising a processor, and a computer-readable storage medium; wherein, the processor is configured to implement each instruction, the computer-readable storage medium is configured to store a plurality of instructions, and the instructions are loaded by the processor to cause the processor to implement the steps of the method for monitoring the icicles base on the adhesive optical fibers according to claim 1.
